(19) United States
(12) Patent Application Publication
(10) Pub. No.: US 2012/0221657 A1
(43) Pub. Date: Aug. 30, 2012

(54) SYSTEM AND METHOD FOR REMOTELY CONTROLLING WEB CONTENT WITH MOBILE DEVICES

(76) Inventors: Gur ZEEVI, Haifa (IL); Itay Gur, Haifa (IL)

(21) Appl. No.: 13/407,344

(22) Filed: Feb. 28, 2012

Related U.S. Application Data
(60) Provisional application No. 61/583,459, filed on Jan. 5, 2012.
(60) Provisional application No. 61/511,007, filed on Jul. 22, 2011.
(60) Provisional application No. 61/447,575, filed on Feb. 28, 2011.

(51) Int. Cl. G06F 15/16

(52) U.S. Cl. 709/206

(57) ABSTRACT

A web-based system that may enable the use of a network-enabled mobile device to interact with and remotely control web content on a network-enabled display device. The mobile device may connect to the display device via a server. The mobile device may send communications to the display device to control an application running on the display device. In response, the display device may send communications to the mobile device to update an application running on the mobile device. The mobile device may be untethered to the display device.

### CROSS-REFERENCE TO RELATED APPLICATIONS

This application claims priority to and the benefit from U.S. Provisional Application No. 61/583,459, filed on Jan. 5, 2012, U.S. Provisional Application No. 61/511,007, filed on Jul. 22, 2011, and U.S. Provisional Application No. 61/447,575, filed on Feb. 28, 2011. These applications are incorporated herein by reference in their entireties.

### TECHNICAL FIELD

This description relates to connecting an untethered network-enabled mobile device to a network-enabled display device and allowing the mobile device to control an application running on the display device.

### BACKGROUND

In systems where information is presented on a display device, there is often a tethered human interface device (HID) that is dedicated to the system which includes the display. For example, in a personal computer, a wired keyboard is often tethered to the personal computer, such that any information typed on the keyboard is passed to the tethered system and processed, after which a result of the interaction may affect the output on the display. With the advent of Bluetooth and other wireless communication protocols, information displayed on the screen of a personal computer may be input via a wireless keyboard or mouse. In this instance, the wireless devices are typically dedicated to the system of the display.

Similarly, in mobile telephones, information input on the telephone's input device typically appears on the screen of the mobile phone. In both instances, the input device is either wired or wirelessly tethered to the system which includes the display. These connections between input devices and displays may be referred to as “permanent” inasmuch as the input device does not have the capability of migrating temporarily to typically disassociated displays In addition theses devices are typically dedicated for the specific purpose of use as input devices for the systems to which they are tethered.

Likewise, when multiple garners simultaneously play a game on a gaming console associated with a display, each gamer typically uses a dedicated controller device “permanently” tethered to the console through either a wired or wireless connection.

### SUMMARY

In accordance with the disclosure, there may be provided a system having server(s) configured to host a primary website, the primary website configured to be displayed within a primary web browser on a network-enabled display device. The server(s) communicate with the network-enabled display device using a display channel connection and communicate with a network-enabled mobile device using a client channel connection. The server(s) create a temporary association between the network-enabled mobile device and the network-enabled display device, the temporary association being based on information received from the network-enabled mobile device. The server(s) also operate as a temporary link between the network-enabled display device and the network-enabled mobile device, and receive at least one message from the network-enabled mobile device. The server(s) further send at least one instruction to the network-enabled display device in response to the at least one message received by the network-enabled mobile device. Additionally, the server(s) permit the network-enabled mobile device to interact with and control an application loaded within the primary web browser and displayed on the network-enabled display device.

According to the disclosure, there may also be provided a method that includes providing a client channel connection between a network enabled mobile device and server(s), and enabling a user of the network-enabled mobile device to send at least one message to the server(s) via the client channel connection. The at least one message enables the creation of a temporary link between the network-enabled mobile device and a network-enabled display device, and causes the server(s) to send a first instruction over to the network-enabled display device via a display channel connection between the server(s) and a network-enabled display device. The first instruction affects a control of a display of information on the network-enabled display device.

Numerous additional features of systems and methods according to the disclosure are described and claimed in the following Detailed Description and are incorporated into this Summary by reference. Therefore, this Summary should be considered exemplary only, and not restrictive of the invention, as claimed.

### BRIEF DESCRIPTION OF THE DRAWINGS

FIG. 1A is a block diagram showing an exemplary system for remotely controlling web content.

FIG. 1B is a block diagram showing an exemplary system illustrating different types of connections allowing for the remote controlling of web content.

FIG. 2A shows an exemplary primary website that may comprise a graphical user interface.

FIG. 2B shows an exemplary secondary website that may comprise a graphical user interface.

FIG. 3 is a flow chart showing an exemplary method allowing a user to access and interact with a primary website when the user is the first to connect.

FIG. 4 is a flow chart showing an exemplary method allowing a user to access and interact with a primary website when other users have previously connected.

FIG. 5 is a flow chart showing an exemplary method allowing a channel owner to switch an application on the display device.

FIG. 6 is a flow chart showing an exemplary method allowing a user to connect to an advertisement displayed on a display device.

### DETAILED DESCRIPTION

Various exemplary embodiments are now described with reference to the accompanying drawings. A number of exemplary embodiments provide technology and methods for permitting one or more users of mobile wireless devices such as cell phones, smart phones, tablets, laptops, netbooks, augmented reality glasses (or any other wireless device connected to a network) to temporarily interact with and control content on a network enabled display device. For example, embodiments of the invention may permit mobile phone users to control content on display devices in public spaces or to control content on private display devices that are not permanently tethered or otherwise dedicated to the user's mobile device. This may enable, for example, a user to interact with an advertisement, game, media, or other content displayed on a public display, or to interact with content on a private display, such as in a home or other private establishment.

With some embodiments, multiple users may use their individual mobile devices to simultaneously (or sequentially) interact with the same or similar content on a network-enabled display. Thus, for example, multiple users each using their own wireless mobile device, may be able to play a game on a single network-enabled display in a public or private space. Similarly, embodiments may enable multiple mobile device users to interact with content displayed on multiple networked display devices in proximity to each other or remote from each other.

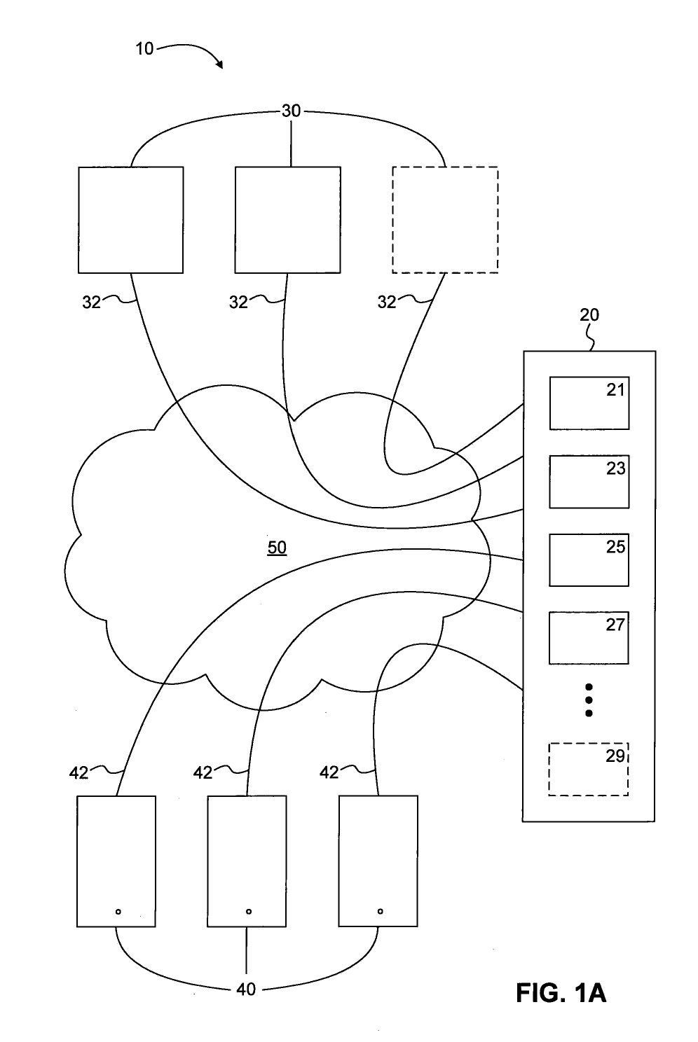

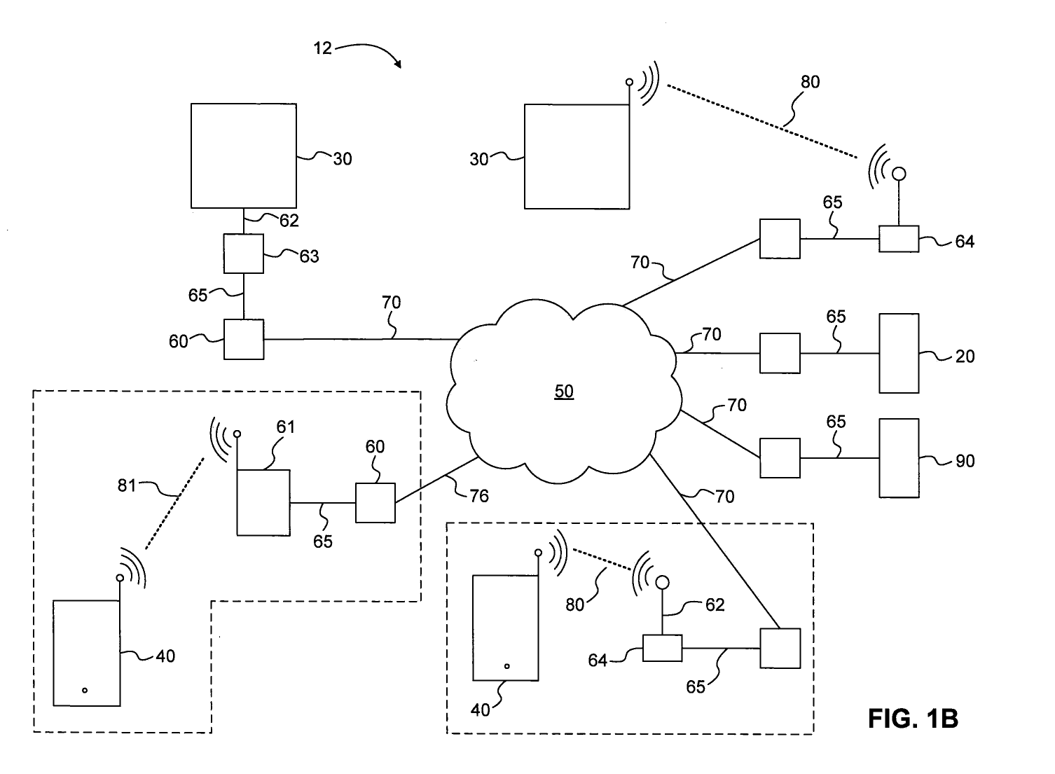

FIG. 1A illustrates an exemplary system 10 for remotely controlling web content according to the present disclosure. The system may be capable of delivering and exchanging communications between server(s) 20, display device(s) 30, and mobile device(s) 40 through a network 50. The display device(s) 30 and mobile device(s) 40 may be client systems to the server(s) 20.

For example, some embodiments may include at least one server configured to provide certain functionality. The functionality may be accomplished, for example, using a single server in a single location; multiple servers in a single location; or multiple servers in multiple locations. When multiple servers are employed, they may cooperate to provide the same or similar functionality, they may each provide separate functionality, or they may share some functions and divide others. Thus, in the example of FIG. 1A, the illustration of server(s) 20 is intended to schematically represent each of these alternatives.

In a broad sense, a server may be a computer program running on a computing device to serve the requests of other programs or “clients”. Additionally or alternatively, a server may include a physical computing device for running one or more services.

The at least one server 20 may include one or more of resource servers 21, services servers 23, channel servers 25, application servers 27, database servers 29 and/or any other server type. A resource server 21 may be a dedicated web server that may host a variety of web resources. Examples of web resources may include HTML, Flash, Unity3D, Java, PHP, JS, Media files, and/or other similar files types or protocols. The resource server 21 may communicate with one or more display devices 30 and mobile devices 40 through a network 50. In some embodiments, the resource servers 21 may provide to both the displays 30 and mobile devices 40 the resources they require upon request.

In some embodiments, one or more services servers 23 may provide a variety of services to the display device 30 and the mobile devices 40. The services may include authentication services to regulate user access to a some website or web platform. The services may also include user application management services that manage a user's use of a specific application; billing services for applications containing fee-based content which require user payment in order to access some or all features and/or content of the application ; messaging and/or email services that enable users to communication with each other using email, SMS, MMS, IM, or other messaging protocols; and application services and database services that provide the user access to a variety of applications and data. Additionally, services may include social network services that enable users to access social networking technology (e.g., Facebook, MySpace, Twitter, Google+) and share their experience and/or find other users with connectivity to the one or more servers; advertisement services that enable the presentation of general ads to the public or personalized ads to a specific user; and backend services supporting the running of applications and/or developer and/or publisher backend services supporting application development and/or distribution and management by third party developers and/or publishers.

In some embodiments of the invention, one or more channel servers 25 may create and manage communication channels to display device(s) 30 and to the one or more mobile devices 40. The channels may act as an abstract transport layer and route communication between different client elements. The display device 30, mobile devices 40, and one or more servers 20 may communicate with each other using these channels.

The channel servers 25 may be designed for scalability and redundancy. This may enable various channel servers 25 to communicate with each other and synchronize state information, and may also enable channel migration and recreation when a specific channel server's resources have reached their limit or the server has malfunctioned. The channel servers 25 may also be designed for symmetric scalability. By way of example, an additional channel server may be loaded to the system when all existing channel servers are fully utilized. Once the new channel server is online, it may query the other channel servers, and existing channels may be migrated to the new channel server to assist with load balancing. In some further embodiments, channel servers 25 may also implement some form of “garbage collection.” This may enable the channel server to mark channels as free when no client is connected and may free the channel resources to be used by other active channels.

In FIG. 1A, the noted functionality of server(s) 20 is exemplary only. Not all of the functions noted are necessarily required to be included in at least one server. Moreover, additional server functionality may be included without departing from the scope and spirit of the embodiments.

Some embodiments may involve one or more display devices 30. By way of example, a display device 30 may be a computer monitor, an electronic billboard, a television screen, laptop screen, tablet device such as an iPad or any other mechanism, connectable to a network, for conveying visual and/or audible information. For simplicity, in FIG. 1A, the illustrated display device(s) 30 is intended to schematically represent each of the foregoing display device options.

The display device(s) 30 may be network-enabled display devices, that is, display devices which may connect to the server(s) 20 through a network 50. A network 50 may include, for example, the Internet, WANs, LANs, analog or digital wired and wireless telephone networks (e.g., PSTN, ISDN, DSL, 3G, 4G), radio, television, cable, satellite, combinations of the forgoing, and/or any other delivery mechanism that enables the transport of data. In FIG. 1A, the illustrated network 50 is intended to schematically represent each of the foregoing and/or combination of the forgoing network options.

Embodiments may involve at least one mobile device 40. By way of example, a mobile device 40 may include a cell phone, laptop, netbook, tablet, iPad, iPod Touch, pager, smart phone, wireless radio, a generic controller apparatus, augmented reality glasses, custom controller apparatus, or any other mobile device capable of transmitting information via a network. Mobile device(s) 40, as illustrated schematically in FIG. 1A, are intended to illustrate one or more of these options.

The mobile device 40 may include a mobile display. For example, the mobile display may be the screen of a cell phone, smart phone, laptop, netbook, tablet, iPad, iPod Touch. The mobile display may enable navigation/control functionality. Additionally or alternatively, a mobile device may enable navigation, control, and/or data input using a graphical user interface (GUI), touch screen or a button, joystick, trackball, or other input mechanism.

As illustrated in FIG. 1A, display device(s) 30 may connect to the server(s) 20 through a network 50 via display channel connection(s) 32. Similarly, mobile device(s) 40 may be network-enabled mobile devices, that is, mobile devices which may connect to the server(s) 20 through a network 50 via client channel connection(s) 42. These channel connections may enable the display device(s) 30 to send and receive communications to and from the server(s) 20. Similarly, mobile device(s) 40 may send and receive communications to and from the server(s) 20 by use of their channel connections. By way of example, such connections may enable the routing of messages between a single mobile device and a single display device, a single mobile device and multiple display devices, multiple mobile devices and a single display device, and/or multiple mobile devices and multiple display devices. The channel connections may also be connected to a single application logic that may be hosted on an application server 27. In some embodiments, the display device 30 may host the application logic.

Channel connections may be established, for example, through use of a channel server 25. Channel server 25 may create a new channel or use a free channel. The channel server 25 may register and unregister a specific display device 30 for connection to server(s) 20. The channel server 25 may send a message or payload from mobile device(s) 40 accessing the server(s) 20 via a client channel connection 42 to a display device 40. The channel server 25 may further send a message or payload to and from the display device to one or more mobile devices 40 connected via the server(s) 20 to a display device 30.

In some embodiments, a channel ID may be assigned to a channel or to a display channel connection 32 after creation or assignment by a channel server 25. A mobile device 40 may use the channel ID to connect to the channel servicing a particular display device 30. Once a mobile device 40 is connected via channels to a display device 30, that mobile device 40 may be enabled to communicate and interact with the display device 30 via the channel server 25.

Multiple alternative protocols may be used for triggering an initiation of communication between a particular mobile device 40 and a particular display 30, and the invention, in its broadest sense, is not necessarily limited to any particular protocol.

By way of example only, an application running on a display device 30 may display a code associated with the display (or application running in the display). A mobile device user may then enter the code into the user's mobile device 40, thereby triggering a connection to be established between a particular display device 30 (or application running on the display) and the user's mobile device 40. By way of another example, a proximity detection mechanism in the user's mobile device 40 and/or in the display device 30 may indicate when a mobile device is in proximity to a display device 30. This may then trigger an auto-connection or an invitation to accept a connection. The proximity detection mechanism may be software-based and/or may include hardware such as GPS, RFID, Bluetooth, a Network Card, NFC, or other hardware that may enable proximity detection. The proximity detection mechanism may identify display devices that are in close proximity to the mobile device and may enable connection to them. In another example, a user of a mobile device may be notified of display device(s) 30 possibly matching one or more of the user's predefined interests, and a connection may thereafter be either automatically established or established by accepted invitation.

Alternatively, a camera within a mobile device 40 may recognize a location and/or a screen display 30 and/or a bar code or other identifier displayed on the display 30, causing the system to trigger a connection or a connection invitation. Additionally or alternatively, a camera or other identification device associated with the display device 30 may identify the mobile device user, and may trigger the system to establish the connection. Such identification may occur, for example, through use facial recognition or through a sensor that identifies the user or mobile device in proximity. Moreover, linkage between a mobile device 40 and a display device 30 may occur through a combination of the forgoing mechanisms.

In some embodiments. at least one server 20 may create a temporary association and establish a session between a network-enabled mobile device 40 and a network-enabled display device 30, the temporary association being based on information received from the mobile device 40. The temporary association may be created as a result of the existence of a connection over one or more display channel connection(s) 32 and client channel connection(s) 42 as previously discussed. The association is referred to as temporary, because it is not a permanent linkage. That is, at some time after the session is complete, a mobile device 40 may become disconnected from the display device 30 to which it was previously connected.

The temporary association may be based on information received from the mobile device 40. Such information, as discussed earlier, may be any information that facilitates identification, including, for example, a code entered on the mobile device 40 identifying the display or application running on the display device 30, selection of an identifier displayed on the mobile device associated with the display device, a signal received by the display device 30 from the mobile device 40, a signal received by the mobile device 40 from the display device 30, a GPS or other location signal, an image from which location can be ascertained, or any other information that may enable one device to link up with another.

This temporary linkage or association may occur, for example, through channel server 25 which may create a client channel connection 42 to a mobile device 40 that has connected to a particular channel related to a particular display device 32. The mobile device may be able to select a channel, for example, over the Internet or other network 50. In some embodiments of the invention, the mobile device 40 may send a message or data to the server 20 in order to communicate with the server 20 to create the client channel connection 42.

The channel may have a unique ID associated with the channel. The unique ID may allow one or more mobile devices 40 to interact with a display device 30 via network 50 by using the unique ID to connect to the channel. In one exemplary embodiment, the unique ID may be displayed on the display device 30. In some embodiments, the mobile device 40 may include identifying information that may allow it to connect to the display device 30. This information may include, for example, a unique device ID or network IP address, user credentials associated with the user using the device or other similar identifying information. The server 20 may use the information to create a client channel connection 42 with the mobile device 40.

After the mobile device 40 has connected to a channel, the server 20 may transform the mobile device 40 into a controller for a particular application loaded onto the display device 30. A separate temporary association may be created for each separate mobile device 40 that connects to a channel associated with a display device 30. The temporary association may be discontinued when the mobile device 40 disconnects from the channel. In this way, a server 20 may operate as a temporary link between the display device 30 and the mobile device 40. Once that temporary link is broken, the mobile device 40 may have no connection or other dedication to the display device 30, as the two are normally disassociated from each other in the absence of a temporary link.

In some embodiments, the one or more mobile devices 30 may include a web browser-equipped mobile device. By way of example, the mobile device may be a cell phone, laptop, netbook, tablet, iPad, iPod Touch, pager, smart phone, wireless radio, a generic controller apparatus, or a custom controller apparatus connected to the Internet via a connection such as Wi-Fi or cellular. A generic controller apparatus may have the ability to interact with and control a variety of applications from a predefined selection or protocol available to third party developers. For example, a particular generic controller apparatus may be able to control all applications developed by a particular third party developer. A custom controller is developed specifically for a particular application. For example, a particular custom controller apparatus may be a specific gaming controller for a particular type of game.

In some embodiments, a mobile device 40 may be identified and the user of the mobile device may be notified of display devices 30 in proximity or in the same local network of the mobile device. By way of example, a mobile device 40 may be identified by an IP address. In other exemplary embodiments, the mobile device 40 may include a functionality that may determine whether it is within a specified distance from a display device 30. In some embodiments, the mobile device 40 may have a proximity sensor that may be activated or deactivated. The proximity sensor may find display devices that are in close proximity to the mobile device and may enable connection to them. In some embodiments, the mobile device 40 may include a functionality that may determine the geographic location of the display devices and the mobile devices. By way of example, GPS, NFC or other similar technology may be used.

In some embodiments, client channel connections 42 may be established for communication between one or more servers 20 and the one or more mobile devices 40. By way of example, these connections, along with a display channel connection 32, may enable the routing of messages between mobile devices 40 that are connected to the same display device 30. These channel connections may be established between a single display device 30, a single application logic, and/or a plurality of mobile devices 40. The display device 30 and the application logic may be hosted on the same physical apparatus.

In some embodiments, a mobile device 40 may communicate with another mobile device via a channel server. The mobile device 40 may communicate with another mobile device through a channel. By way of example, communications sent by mobile devices may be routed via the channel server 25 based on the associated channel. Therefore, each mobile device 40 is aware of the channel but is not directly aware of other mobile devices 40 connected to the channel. The mobile devices 40 may connect to the same channel and may broadcast messages to each other and query information about each other via that channel.

In some embodiments, the channel server 25 may implement a channel communication protocol. By way of example, this may be a dedicated protocol for message transport that may be implemented in the application layer of a network stack or in other similar ways. Mobile devices 40 and display devices 30 may implement this protocol in order to communicate with each other via client channels. Client channels may also be used to synchronize, send and receive information between the clients and a channel server servicing that channel. This may allow the clients to update states. This may enable channel resources to be migrated to other channel servers for better load distribution or enable the recreation of previously existing channels. In addition, channel servers may have a connection to services enabled by the services server, such as user authentication, that may be utilized as needed. The channel communication protocol may allow room for expansion to enable additional capabilities.

In some embodiments, the server 20 may receive at least one message from the mobile device 40 over the client channel connection 42. In one exemplary embodiment, the message may be a request to the server 20 to connect to the server and be associated with a specific channel. The message may request that the server 20 allow the mobile device 40 to access an application on a particular display device 30. In one exemplary embodiment, the message may comprise a command from the mobile device 40 to perform a certain function of an application running on the display device 30.

In some embodiments, a server 20 may send, in response to the message, at least one instruction to a display device 30 over the display channel connection 32. In one exemplary embodiment, the instruction may comprise a command to the display device 30 to perform an action requested by an associated mobile device 40. By way of example, the server 20 may send instructions that are associated with a particular mobile device 40. When the server receives messages from a specific mobile device 40, the server may instruct the display device 30 to access content on a primary website hosted on the server 20 to be displayed on the display device 30.

In some embodiments, the server 20 may permit the mobile device 40 to interact with the display device 30. By way of example, the server 20 may allow the mobile device 40 to act as a controller to send commands to the display device 30 after the server 20 has enabled the mobile device 40 to connect to the associated channel. Examples may include commands by the mobile device to navigate an application catalog, commands to select an application from a catalog, and commands to control and interact with certain functions of the loaded application (e.g., moving a player in a game around the screen, selecting a card to play in a game of cards, navigating menus and supporting the selection of items, and any other interaction that is required by the application).

FIG. 1B illustrates an exemplary system 12 for remotely controlling web content according to the present disclosure. The system illustrates exemplary connections for delivering and exchanging communications between server(s) 20, display device(s) 30, mobile device(s) 40, and third party server(s) 90, through the network 50. The display device(s) 30 and mobile device(s) 40 may be client systems to the server(s) 20. The third party server(s) 90 may manage services provided by one or more third party service providers.

In some embodiments, the server(s) 20, display device(s) 30, mobile device(s) 40, and third party server(s) 90, may be connected to the network 50 via an ISP connection 65 connected to an ISP 60 and an Internet backbone 70. In some embodiments, the connections may be via wired, wireless, or cellular technology. By way of example, a display device 30 may connect to an ISP connection 65 via a wired network 62 connected to a modem/router 63. The wired network 62 may be a LAN, WAN, or other network. In another example, a display device 30 or a mobile device 40 may connect to an ISP connection 65 via a wireless network 80 connected to a wireless modem/router 64. The wireless network 80 may be Wi-Fi, Bluetooth, or other wireless protocol. The wireless modem/router 64 may be a single entity or a separate wireless router 62 and modem 64 connected via a wired network 62. In another example, a display device 30 or a mobile device 40 may connect to an ISP connection 65 via a cellular network 81 connected to a cellular provider 61. The cellular network 81 may be 3G, 4G, EDGE, or other cellular network.

In some embodiments, the server 20 may host a primary website. By way of example, the primary website may include a set of related web pages containing content or media including text, video, music, audio, images, code, or other similar media that may be accessed and/or displayed on a display device 30. The primary website may be hosted on at least one web server 20, accessible via a network using a URL. In some embodiments, the display may access the primary website and all further interaction and control of display device 30 may be done via connected mobile devices 40.

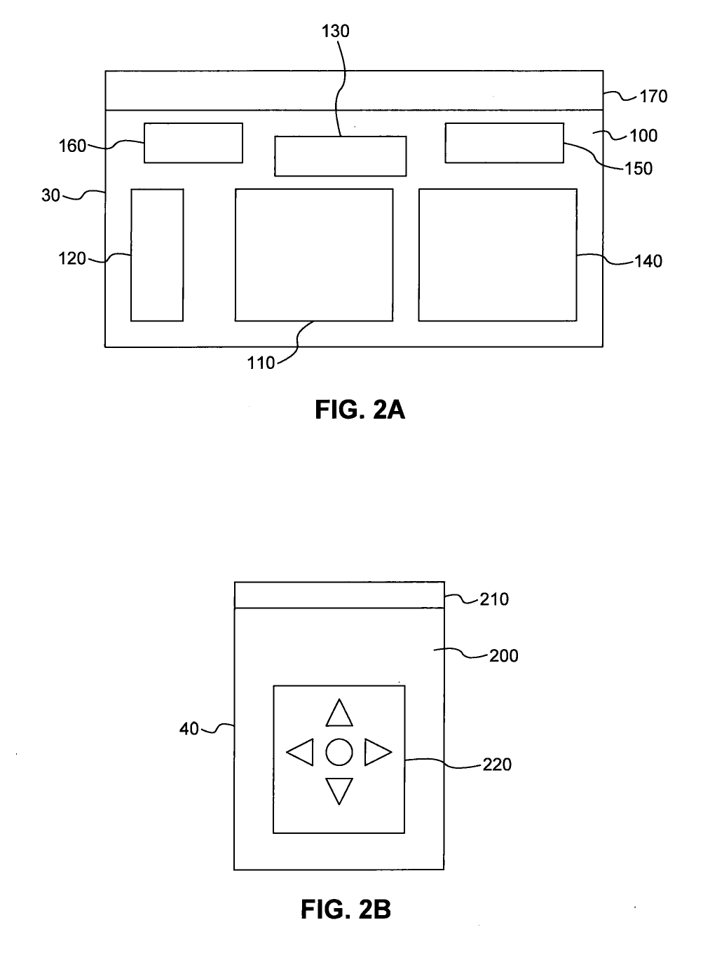

By way of example, the primary website 100 may comprise a graphical user interface, as shown in FIG. 2A. The graphical user interface may be displayed on the display device 30 and may enable a user to interact with various selectable options to select some desired functionalities. These functionalities may include logging into the primary website 100, establishing a connection between a mobile device 40 and a display device 30, and interacting with applications on the display device 30.

In some embodiments, the primary website 100 may allow for the display of categories and sub-categories of content. For example, these categories may include a list or catalog of available applications and/or games 110, a promotional and/or advertisement area 120, a search area 130 that allows searching a catalog of applications and that may cause the display device 30 to change dynamically to show the results, application and/or category descriptions 140, a channel ID 150 associated with the channel enabling communication with the display device, and a logo area 160 for sponsors and/or the owner of the primary website. In a broader sense, the primary website 100 may include any location or a group of locations that permits a hosting of content, regardless of the content.

In some embodiments, a primary web browser 170 may enable access to the primary website 100. The primary web browser 170 may run on the display device 30. The primary browser 170 may include, for example, any software application that enables retrieving, presenting, playing media, executing code and traversing information resources on the Internet or other network 50.

Embodiments may include a secondary website 200 hosted on the server 20. By way of example, the secondary website may include a set of related web pages containing content or media including text, video, music, audio, images, code, or other similar media that may be accessed and/or displayed on a network-enabled mobile device. The secondary website may be hosted on at least one web server, accessible via a network using a URL. In one exemplary embodiment, the secondary website may be the same as the primary website. In another exemplary embodiment, the secondary website may be different than the primary website. In another exemplary embodiment, the secondary website may contain content similar to the primary website 100 but in a form conducive to display on a mobile device 40. In another exemplary embodiment, the secondary website 200 and the primary website 200 may share resources, services, content, media, code, images, audio, video or other similar media or data.

By way of example, the secondary website 200 may comprise a graphical user interface, as shown in FIG. 2B. The graphical user interface may be displayed on the mobile device 40 and may enable a user to interact with various selectable options to select some desired functionalities. These functionalities may include logging into the secondary website 200, establishing a connection between a mobile device 40 and the server(s) 20, creating an association to a channel and creating a temporary link to a display device 30 associated with that channel, and interacting with applications displayed in the web browser on the display device 30.

In some embodiments, the mobile device 40 may use the secondary website 200 to interact with and control an application catalog 140 or an application loaded and displayed in a web browser on the display device 30 available via the primary website 100. The secondary website 200 may then load a controller configuration 220 that a user may use to interact with and control the application running in the web browser on the display device 30. In one exemplary embodiment, the controller configuration 220 may be generic and may be used to be compatible with multiple applications. In another exemplary embodiment, the catalog or loaded application may have a specific customized controller configuration associated with and compatible to control only a particular catalog or application. The controller configuration 220 may be loaded by the secondary website 200 on the mobile device 30 when a user connects to a display device 30 currently accessing the primary website 100. In some embodiments, the controller configuration 220 may be used for one or more of the following: navigating a catalog and available applications on the primary website displayed on the display device, choosing an application after locating the desired application, controlling and interacting with the selected application, entering search keywords for searching within the current application displayed on the display device, and joining an existing application already loaded onto the display device.

In some embodiments, a secondary web browser 210 may enable access to the secondary website 200. The secondary web browser 210 may run on the network-enabled mobile device 30. The secondary browser 210 may include, for example, any software application that enables retrieving, presenting, playing media, executing code and traversing information resources on the Internet or other network. The secondary web browser 210 may be the same as or different than the primary web browser 110.

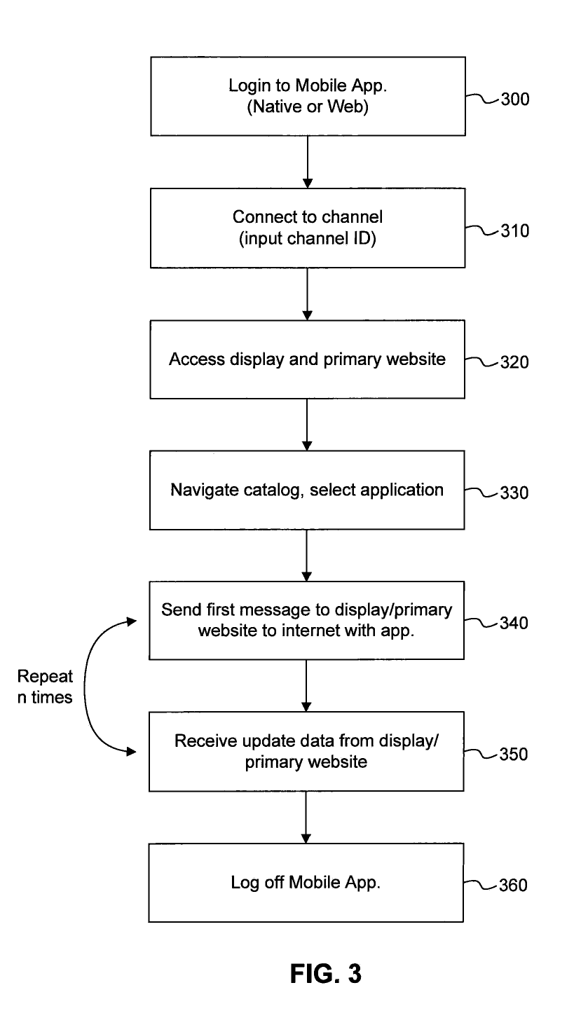

FIG. 3 shows an exemplary method allowing a user to access and interact with the primary website 100. A user may use a mobile device 40 to connect to a display device 30. In step 300, the user may open the secondary web browser 210 on the mobile device 30 and connect to the secondary website 200. In one exemplary embodiment, the user may enter user credentials, such as a login name and/or a password, in order to gain access to part or all of the features available via the secondary website 200.

In some embodiments of the invention, the user may use a native application installed on the user's mobile device 40 to communicate with the server(s) 20 and interact with and control a display device. By way of example, a native application may include an application loaded into the mobile device's operating system or platform. In some embodiments, the native application may be downloaded for a widely available mobile platform such as iPhone, Android, Windows Phone 7, or Blackberry. In some embodiments, the native application may have access to the secondary website 200 in order to download and update controller configurations available to the native application in order to allow the support of interaction with and control of applications loaded and displayed on the display device. In some embodiments, the native application can be designed to support and enable all the features and functions available via the secondary website as previously discussed. In some embodiments, the native application may enable the user to use features of the mobile device that may not have the ability to be implemented via a web application. These features may include, for example, use of the mobile device's camera, accelerometer, multi-touch services, and geo-location/GPS services.

In some embodiments, the user may use a “mobile application” loaded into the secondary web browser 210 to access the secondary website 200. In some embodiments, the “mobile application” may be fully developed as a web application in order to allow a user to interact with the mobile platform without the need to install a native application on their mobile device. The web application may allow the user to login to the secondary website, connect to a display, set up profile settings, create user events and invitations, access a message center, access a list of friends, and access a list of played, purchased or available applications. In some embodiments, the content of the web application may support and/or include many of the currently available web technologies, such as Flash, HTML5, Unity 3D, and any other suitable web technology. Third party developers may be able to develop web applications in any technology and choose the right development framework for their needs.

In step 310, the user may connect to a channel between the display device 30 and a server 20 by use of a native application or web application available on the mobile device. In one exemplary embodiment, the user may enter a unique channel ID that is associated with the display device 30 or the channel associated with the display device. Once the user enters the channel ID, the server may establish a temporary client channel connection between the mobile device and the server that connects the mobile device to the channel between the server and the display device.

The user may send messages to the display device 30 after the user's mobile device 40 is connected to the channel. In step 320, using the mobile device, the user may access the primary website displayed in the primary web browser. In one exemplary embodiment, a default controller configuration may be displayed on the user's mobile device upon connection to a display. The user may navigate the primary website displayed in the web browser on the display, make selections, interact and control via the default controller configuration.

In some embodiments, the primary website 100 may include a list or catalog of applications. In some embodiments, the catalog may be the default first page that is displayed when a display connects to the system. In a further embodiment, the catalog may be an application that may act as the gateway to all other applications available on the platform. In step 330, by way of example, the user may access the catalog upon connecting to a display displaying the primary website. The user may navigate the catalog and make selections via the default controller configuration. In some embodiments, the catalog may comprise a scrollable list of selectable graphics, each graphic representing a selectable application. Using the catalog, the user may choose the specific application that will be loaded from the catalog into the same display.

In some embodiments, a description may be displayed for different entries in the catalog. By way of example, the entries may comprise entries for category, subcategory, game name, application name, and other similar listings. In some embodiments, the description may consist of a visual representation or an auditory description. The description may have a special area that may be displayed in the catalog and may present the current location of the user in the catalog.

In some embodiments, the catalog may have a search capability. A search area may enable the user to enter a keyword or numerical input on the mobile device and perform a search of the entire catalog on the display device. The search may provide search results of games, applications, and other suitable results. In some embodiments, the search results may be organized to display results based on relevancy. By way of example, relevancy criteria may comprise exact match, partial match, description match, and context match. In some embodiments, the search results may be presented as a list of all found items. The list may be presented in the catalog under a virtual category called search results. In some embodiments, a maximum number of displayed search results may be set. In some embodiments, the catalog may have generic navigation capabilities. In some embodiments, a set of icons may be selected and used to navigate through the catalog. By way of example, the user may use these icons to move between categories, move from one tree level to another, scroll or flip through a listing of games or applications, and select a game or application.

Once the user has selected a desired entry from the catalog, the selected application may be loaded into the primary web browser. In some embodiments, the application may be a game, movie, interactive advertisement, web application, or any other similar interactive software application.

In some embodiments, the applications may comprise external services. By way of example, these may be services hosted by third party service providers on third party servers. The primary website 100 hosted on the at least one server 20 may use external services directly from the third party servers. By way of example, an application that may be available in the catalog that may comprise external services is YouTube. All the video content displayed within a YouTube application may be available via an open source YouTube API available from the YouTube website. Additional examples may comprise applications that access game scoreboards using external services (e.g., online poker rooms) and VOD applications such as Netflix, Hulu, and other similar applications.

In some embodiments, the desired application may include fee-based content that requires payment in order to access the application content. By way of example, the server may check if the user needs to submit payment in order to access some selected applications, application features or content. A payment process may be initiated, displayed on the user's controller, and received by one or more servers if an application contains fee-based content. In some embodiments, the payment transaction may be submitted directly to the server(s) 20. In another embodiment, the payment transaction may be performed by third party servers. In some embodiments, at least one database, server, or service available to the server(s) 20 may be updated to indicate a successful payment process. The update may indicate that the purchased fee-based content should be available to the purchasing user.

Once the application is loaded via the primary website into the web browser on the display device 30, a controller configuration is loaded into the web application or native application on the associated mobile device(s) 40. The controller configuration may be a generic controller configuration or a specific controller configuration compatible with the application loaded onto the web browser 170 on the associated display device 30. In step 340, the user may interact with and control the application by entering inputs using the controller on the mobile device and sending messages to the display device. The application is updated based on the messages received from the mobile device.

In step 350, application update data may be sent from the display device to the mobile device in response to the messages sent by the mobile device or in response to changes in the application state. The update data may dynamically update the display device and mobile devices as an application is used and controlled by a user. The update data may be sent by the display device to the mobile device. In some embodiments, a portion of data displayed about the application may appear on the display device and a portion of data may appear on the one or more mobile devices while the mobile devices are interacting with an application on the display device. Information displayed on the display device and/or on the mobile devices may dynamically change as the application is controlled. In some embodiments, the data presented on the mobile device and the display device may be the same. In another embodiment, the data presented on the mobile device may be different than the data presented on the display device.

In some embodiments, multiple mobile devices may interact with the application loaded on a display device. In some embodiments, multiple mobile devices may control an application displayed on the display screen at the same time. The data presented on each mobile device may differ when a plurality of mobile devices are connected to a display device. For example, an application may display private information on a mobile device that may be particular to the specific user using the mobile device.

In step 360, Once the user has finished the desired interaction with the application currently displayed on the display device, the user may exit or logoff the application on the mobile device to quit his session or return to the application catalog to search for and select a new application to interact with.

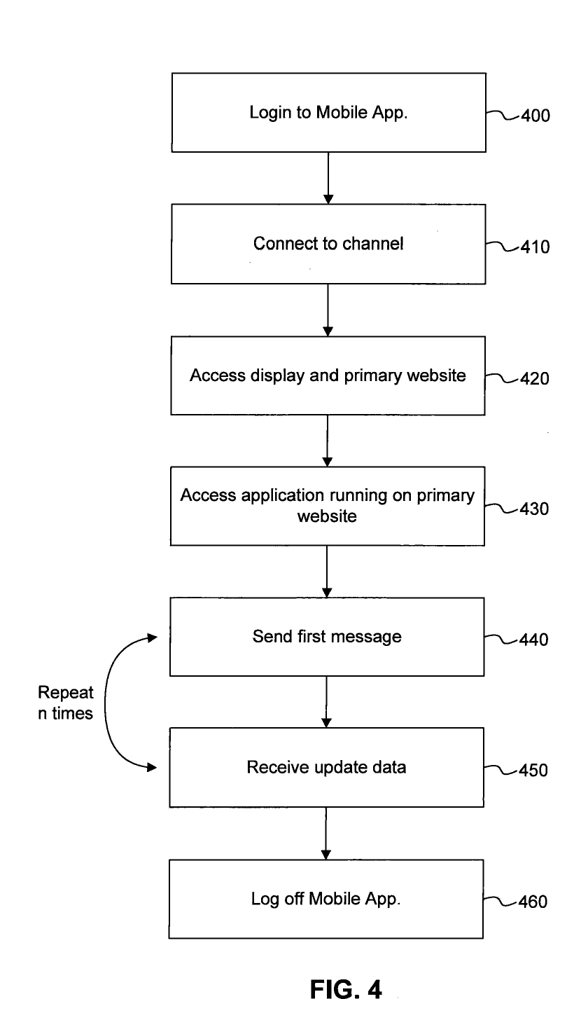

FIG. 4 shows an exemplary method allowing a user to interact with an application that is already displayed on a display device. By way of example, a user may see a display device running a game of interest to the user and the user may desire to connect to the game and possibly even join other users already playing the game whether on the same display or separate displays. In step 400, the user may log into a mobile application using his mobile device. In step 410, the user may connect to the existing channel by entering the channel ID of the channel into the mobile application. In step 420, the user may then access the application available in the web browser on the associated display device once the mobile device 40 has been connected to the channel. In step 430, the user may then access the application on the display device using his mobile device as a controller. In step 440, the mobile device may send messages to the display device to interact with the application. In step 450, the display device may send update data to the mobile device in response to the messages sent from the mobile device. The user may interact with the application as long as the application is loaded on the display device. In step 460, when a user has completed the desired interaction he may log out of or exit the application on the mobile device 40 and end his session or quit the application on the display device 30 and return to the catalog. In some embodiments of the method displayed in FIG. 4, the user may not quit the currently running application to access the application catalog or switch the application to another application.

In some embodiments of the invention, the mobile device may include user capabilities enabling a user to become a “channel owner.” The user capabilities may allow the first user to connect to a display device to become an owner device. In some embodiments, although other mobile devices 40 may be connected simultaneously to the same channel and the same display device 30, only the channel owner may be permitted to interact with the catalog. In some embodiments, a channel owner may decide when to leave a game and when to return to the catalog. The channel owner may also decide which application to select. Once the channel owner disconnects from the channel, the most senior mobile device still connected to the channel may be promoted to channel owner.

In an alternative embodiment, if any connected user wants to exit the current application and return to the catalog, all controllers may receive a leave request. If a majority of users agree to exit the existing application, the users may exit the application and return to the catalog. If a majority of users do not agree, the application may remain on the display, these are just a few examples of rules that can be enforced in order to select a channel owner and/or grant the right to specific features such as application switching that should be available only to part of the users currently associated with the display.

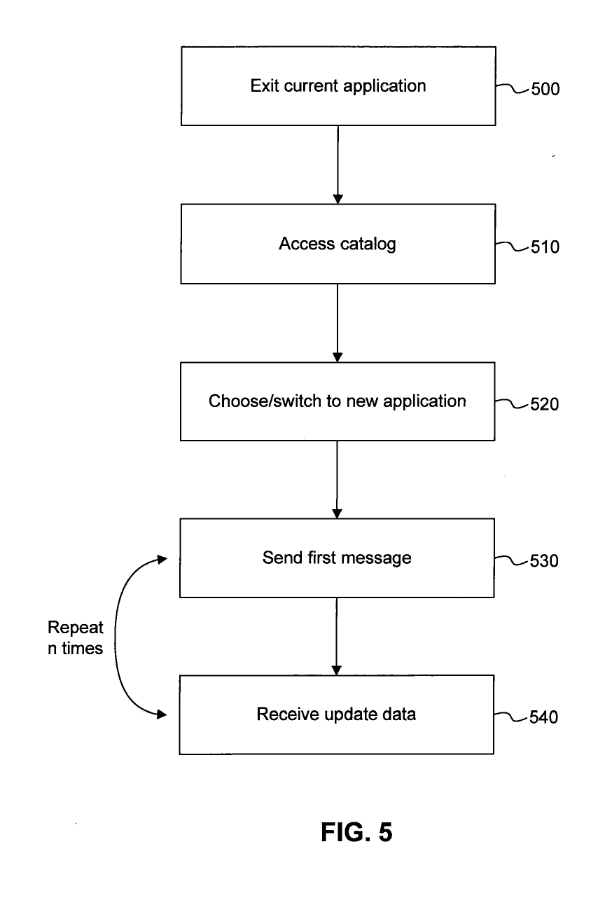

FIG. 5 shows an exemplary method allowing a channel owner to change the application on the display device 30. In step 500, the channel owner may exit from the currently running application. This may be in response to a decision by a channel owner or a majority decision by the other users connected to the display device 30. In step 500, the channel owner may access the catalog screen and navigate the list of applications 110. In step 510, the channel owner may select an application from the application catalog. Once the channel owner selects an application, the new application may be loaded onto the display device to replace the previously loaded application. In step 530, the channel owner and the other mobile devices connected to the display device may then send messages to the display device to interact with the application. In step 540, the mobile devices may receive update data from the display device in response to the sent messages.

In some embodiments, the channel owner can select from within the mobile application from a list of available applications that can be switched to and loaded on the associated display, without the need to switch back to the catalog on the display device. In this case the native or web application on the mobile device can support a feature such as to display a list of all available applications, recently played, purchased or other categories, that can be navigated and selected directly on the mobile device, such that when the selection occurs on the mobile device the application is loaded on the associated display device.

In some embodiments, the primary website 100 may include a locking feature. The locking feature may enable a display device 30 to be locked within a specific application once that application is loaded onto the display device 30. By way of example, locking the display device 30 may not allow connected mobile devices 40 to exit the application, access the catalog, or change the current application to another application. By way of example, this feature may be specifically useful for the public domain where an advertisement, game or any application may be displayed on a public digital billboard and may be locked to the current application to prevent prospective users from changing the displayed application. In some embodiments, a display device 30 may be locked to present a some advertisement for a specific predefined period of time, in which no other advertisement may be displayed during that period of time.

In some embodiments of the invention, applications may include advertisements that encourage users to buy goods or services. By way of example, these may be user-controlled, interactive ads. These interactive ads may include games or other interactive portions as part of the advertisement.

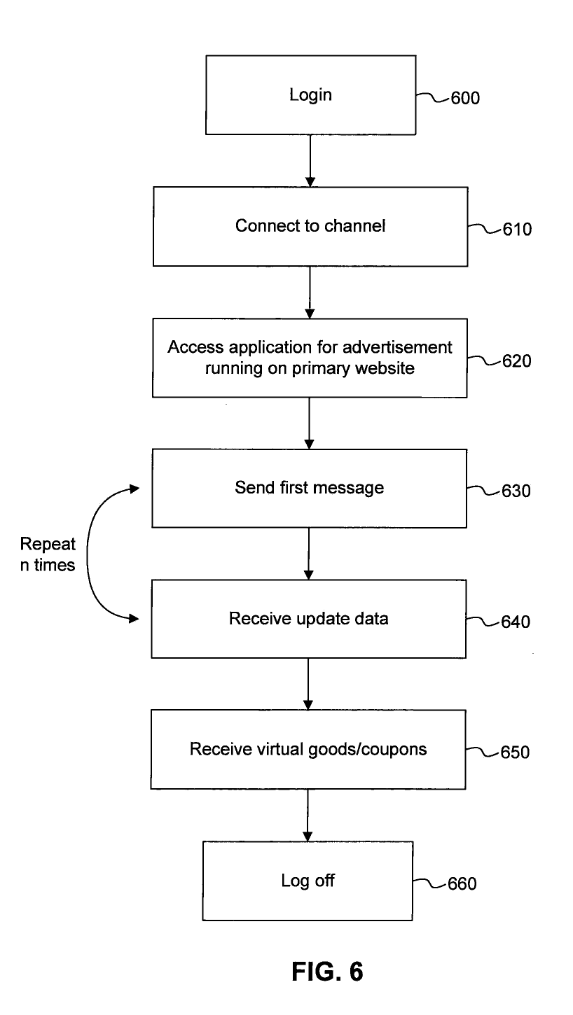

FIG. 6 shows an exemplary method allowing a user to connect to an advertisement on a display device. In some embodiments, the advertisement is displayed on a public display device. The advertisement may be locked to prevent the advertisement from being switched by users. In some embodiments, the advertisement may publicly display information that may be generalized to a general audience or personalized based on user profile information detected from a mobile device of a user in the vicinity of the advertisement.

In step 600, if a user desires to connect to the advertisement, the user may log into the mobile application using his mobile device. In step 610, the user may connect to the existing channel by entering the channel ID of the channel into the mobile application. In step 620, the user may then access the application on the display device using his mobile device as a controller. In step 630, the mobile device may send messages to the display device to interact with the application. In step 640, the display device may send update data to the mobile device in response to the messages sent from the mobile device. In step 650, the user may interact with the application as long as the application is loaded on the display device. In step 660, the user may log out of the mobile application and terminate his session when the user has completed the desired interaction with the display device.

In some embodiments, a user may receive some virtual goods or coupons that may be given to a user who accesses the advertisement. The user may gain some virtual goods based on the user's interactivity with the advertisement under some conditions defined by the advertiser. In some embodiments, there may be no conditions for the receipt of virtual goods. Earned virtual goods may be transformed into other online activity of the user after leaving the advertisement. Similarly, earned coupons may be redeemed by the user at selected locations or online as defined by the advertiser. In some embodiments, the virtual goods and coupons may be budget controlled by the advertisers and may be limited by amount, time, or location.

In some embodiments, the platform may be configured to allow and support the expansion of applications, that can be loaded and displayed on display devices and controlled by mobile devices. By way of example: Third party developers and/or publishers may have the option to develop their applications and a controller components, ether generic or customizable, based on common web technologies such as HTML5, PHP, Flash, Unity3D, Java WebGL and any other web based technology and submit them to be available on the platform via the catalog or elsewhere. In some embodiments the developers and/or publishers may have the option to select a revenue model, set a price tear for the applications or features in their applications and optionally get access to statistics regarding their application sales and/or usage.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the systems and methods disclosed herein. It is intended that the specification and examples be considered as exemplary only, with a true scope of the disclosure being indicated by the following claims and their equivalents.

We claim:

1. A method, comprising:
providing a client channel connection between a network enabled mobile device and at least one server, and
enabling a user of the network-enabled mobile device to send at least one message to the at least one server via the client channel connection, the at least one message enabling:
creating a temporary link between the network-enabled mobile device and a network-enabled display device; and
causing the at least one server to send a first instruction over to the network-enabled display device via a display channel connection between the at least one server and the network-enabled display device, the first instruction affecting a control of a display of information on the network-enabled display device.

2. The method of claim 1, wherein the at least one message includes a first component for creating the temporary link between the network-enabled mobile device and the network-enabled display device and a second component for causing the at least one server to send the first instruction over to the network-enabled display device via the display channel connection between the at least one server and the network-enabled display device, the first instruction affecting the control of a display of information on the network-enabled display device.

3. The method of claim 2, wherein the display of information on the network-enabled display device occurs via a primary website accessed by a primary web browser available on the network-enabled display device.

4. The method of claim 2, wherein the network-enabled mobile device includes a native application installed on the network-enabled mobile device, the native application enabling the network-enabled mobile device to communicate with the at least one server and interact with the network-enabled display device.

5. The method of claim 3, wherein when the network-enabled mobile device loads and displays a secondary website using a web browser application installed on the network-enabled mobile device, the secondary website enables the network-enabled mobile device to communicate with the at least one server and interact with the network-enabled display device.

6. The method of claim 3, further comprising:
enabling communication, via the at least one server, with a plurality of network-enabled mobile devices using a plurality of client channel connections;
enabling a temporary link between the network-enabled display device, and the plurality of network-enabled mobile devices; and
enabling the plurality of network-enabled mobile devices to simultaneously interact with the content currently loaded within the primary web browser on the network-enabled display device.

7. The method of claim 1, further comprising:
enabling a receipt of a second instruction, by the at least one server, from the network-enabled display device; and
enabling a sending of a message to the network-enabled mobile device in response to the second instruction received by the network-enabled display device.

8. The method of claim 1, further comprising supporting, by the at least one server, a use of external services available from a plurality of third party service providers.

9. The method of claim 3, wherein the primary website is further configured to support the use of external services available from a plurality of third party service providers.

10. The method of claim 5, wherein the secondary website is further configured to support usage of external services available from a plurality of third party service providers.

11. The method of claim 5, wherein the primary website and the secondary website are hosted on the at least one server and share resources and services.

12. The method of claim 5, further comprising sending update data to the network-enabled mobile device, the update data associated with the content loaded in the primary web browser on the network-enabled display device;
updating content in the secondary web browser; and
enabling interaction between the secondary web browser on the network-enabled mobile device and the primary web browser on the network-enabled display device.

13. The method of claim 4, further comprising
sending update data to the network-enabled mobile device, the update data associated with the content loaded in the primary web browser on the network-enabled display device;
updating content in the native application; and
enabling interaction between the native application on the network-enabled mobile device and the primary web browser on the network-enabled display device.

14. The method of claim 3, further comprising supplying, by the at least one server, a list of available applications that can be loaded and displayed within the primary web browser on the network-enabled display device and controlled by the network-enabled mobile device.

15. The method of claim 3, further comprising:
enabling a display, by the primary website, of a catalog of available applications that can be navigated;
enabling the selecting of an application from the catalog; and
enabling the loading of the selected application into the primary web browser, wherein the selection and navigation is performed by the network-enabled mobile device.

16. The method of claim 3, further comprising enabling a user of the network-enabled display device to select between a plurality of applications for display in the primary web browser on the network-enabled display device.

17. The method of claim 3, further comprising:
enabling communication between the network-enabled display device and a plurality of network-enabled mobile devices using a plurality of client channel connections, such that a temporary association occurs between the network-enabled display device and the plurality of network-enabled mobile devices;
enabling the plurality of network-enabled mobile devices to simultaneously interact with an application loaded within the primary web browser on the network-enabled display device; and
enabling an updating, by the at least one server, of the plurality of network-enabled mobile devices temporarily associated with the network-enabled display device when the application in the primary web browser on the network-enabled display device is switched.

18. The method of claim 3, further comprising:
enabling communication between the network-enabled display device and a plurality of network-enabled mobile devices using a plurality of client channel connections, such that a temporary association occurs between the network-enabled display device and the plurality of network-enabled mobile devices;
enabling the plurality of network-enabled mobile devices to simultaneously interact with an application loaded within the primary web browser on the network-enabled display device; and
enabling one of the plurality of network-enabled mobile devices to access at least one feature unavailable to others of the plurality of network-enabled mobile devices.

19. The method of claim 1, further comprising allowing, by the at least one server, expansion of content and functionality by third party developers, wherein the expansion comprises an addition of at least one of applications, associated controllers and services.

20. The method of claim 3, further comprising enabling a locking of the network-enabled display device, wherein the locking prevents each of the network-enabled mobile devices associated with the network-enabled display device from switching a current application running in the primary web browser on the network-enabled display device.

21. The method of claim 1, further comprising enabling a distribution of advertisements to a plurality of network-enabled mobile devices via the at least one server.

22. The method of claim 3, further comprising enabling the display of advertisements on a plurality of network-enabled display devices.

23. The method of claim 4 or 5, further comprising enabling the display of advertisements on a plurality of connected network-enabled mobile devices via the application loaded on each of the plurality of connected network-enabled mobile devices.

24. The method of claim 1, further comprising validating, by the at least one server, payment when a user of the network-enabled mobile device desires to interact with an application comprising fee-based content.

25. The method of claim 24, further comprising enabling and supporting a payment process made by the user by using an application available on the user's network-enabled mobile device.

26. The method of claim 1, wherein the temporary link between the network-enabled mobile device and the network-enabled display device is based on a network IP address of the network-enabled mobile device.

27. The method of claim 1, wherein the temporary link between the network-enabled mobile device and the network-enabled display device is based on an identifier associated with the network enabled display device and transmitted via the network-enabled mobile device.

28. The method of claim 1, wherein the temporary link between the network-enabled mobile device and the network-enabled display device is based on a proximity between the network-enabled mobile device and the network-enabled display device.

29. The method of claim 1, wherein the at least one message sent to the at least one server from the network-enabled mobile device is based on a geo-location of the network-enabled mobile device.

30. The method of claim 1, wherein the at least one message sent to the at least one server from the network-enabled mobile device is based on credentials of a user operating the network-enabled mobile device.

31. The method of claim 1, wherein the at least one server is further configured to receive a second instruction from the network-enabled display device and send at least one messages to a plurality of network-enabled mobile devices.
